(19) United States
(12) Patent Application Publication
(10) Pub. No.: US 2014/0150241 A1
(43) Pub. Date: Jun. 5, 2014

(54) REINFORCEMENT SCREW INSERT

(71) Applicant: Patricia McNeal, Stephens City, VA (US)

(72) Inventor: Patricia McNeal, Stephens City, VA (US)

(21) Appl. No.: 14/082,413

(22) Filed: Nov. 18, 2013

Related U.S. Application Data
(60) Provisional application No. 61/727,198, filed on Nov. 16, 2012.

(51) Int. Cl. F16B 25/10

(52) U.S. Cl. CPC F16B 25/10
USPC 29/525.02; 411/387.4

(57) ABSTRACT

A secondary screw that is used to penetrate through a conventional threaded screw. The secondary screw is inserted into a conventional screw that might be mounted or inserted into a wall or a post. The secondary screw provides a means to avoid leaving a hole in a wall or post by removing the primary threaded screw. In one particular embodiment, a primary screw is inserted into a wall, then the secondary screw screws into the top head of the primary screw. This arrangement enables a user to use the secondary screw as a means to hang any object upon the screw or mount any object through the use of the secondary screw.

### CROSS REFERENCE TO OTHER APPLICATIONS

This application claims priority to U.S. Provisional Application Ser. No. 61/727,198 filed on Nov. 16, 2012.

### BACKGROUND OF THE INVENTION

1. Field of Invention

The present invention relates to a screw that is inserted into an existing screw to provide a reinforcement of the existing screw. The reinforcement screw helps to eliminate the necessity for repeated holes in an existing wall.

2. Description of Related Art

A screw is a type of fastening device that secures either two objects together or is used to position an object on a wall or a post. A typical screw includes a head and a body, where the body is normally a stem that is threaded. The threaded portion of the screw may vary whereas the screw is designed to adjoin bolt or other threaded opening so that the screw is bound securely within the bolt or opening. Further the screw may include tapered threading so that the screw penetrates the object. Typically self-threading screws do not require an adjoining opening or bolts to secure the screw. Self-threading screws normally are used to mount objects on a wall or post and may include various shapes and sizes. The tapered or self-threading screw typically leaves a hole in the object once it is removed. The abandoned hole can diminish the appearance of the wall, post or stud that is mounted with the screw. Consequently, it would be helpful to have an alternative solution to avoid these mounting problems.

### SUMMARY OF THE INVENTION

The present invention relates to a dual screw configuration comprising: a primary screw, where the primary screw includes a head and a stem, further where stem includes self taping threads; and a secondary screw, where the secondary screw includes a head and a stem, where the stem of the secondary screw inserts into the head of the primary screw. The secondary screw may provide temporary usage and is removable after use. The primary screw remains in the wall permanently after removal of the secondary screw and may be screwed flush with the wall surface.

### BRIEF DESCRIPTION OF DRAWINGS

FIG. 1 depicts a secondary screw used in conjunction with a primary screw.

### DETAILED DESCRIPTION

The present invention relates to a secondary screw that is used to penetrate through a conventional threaded screw. The secondary screw is inserted into a conventional screw that might be mounted or inserted into a wall or a post. The secondary screw provides a means to avoid leaving a hole in a wall or post by removing the primary threaded screw. In one particular embodiment, a primary screw is inserted into a wall, then the secondary screw screws into the top head of the primary screw. This arrangement enables a user to use the secondary screw as a means to hang any object upon the screw or mount any object through the use of the secondary screw.

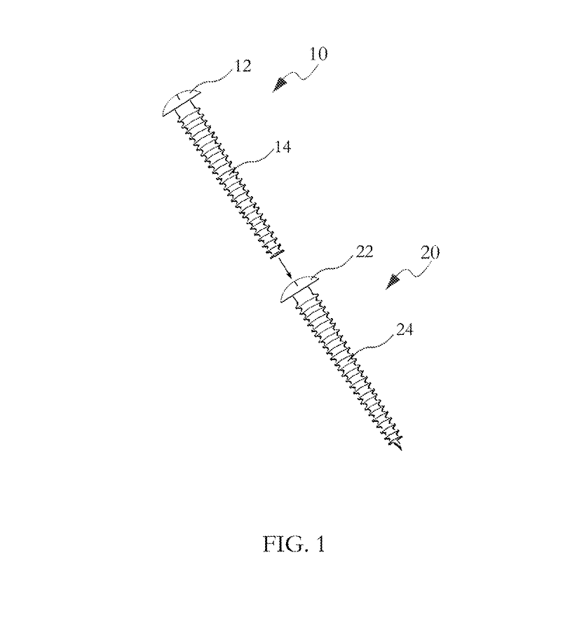

In reference to FIG. 1 a primary screw 20 is depicted. Above the primary screw 20 is a secondary screw 10. The secondary screw 20 inserts through an opening in a head 22 of the primary screw 20. The primary screw 20 includes a threaded stem 24 that includes a self-threading configuration. This primary screw 20 may be inserted into a wall, and then a secondary screw 10 is inserted into the primary screw 20. The secondary screw 20 also includes a threaded stem 14 and a head 12. During use the primary screw 20 is inserted into the wall and then receives the secondary screw 10 for mounting purposes. A user simply removes the secondary screw 10 once the use of the combined configuration of the primary screw 20 and secondary screw 10 is complete. The present invention avoids leaving a hole in the wall and therefore the primary screw may be simply inserted fully into the wall and the hole remains plugged with the primary screw 20. The instant invention has been shown and described in what it considers to be the most practical and preferred embodiments. It is recognized, however, that departures may be made there from within the scope of the invention and that obvious modifications will occur to a person skilled in the art.

What is claimed is:

1. A dual screw configuration comprising:
a. a primary screw, where the primary screw includes a head and a stem, further where stem includes self taping threads; and
b. a secondary screw, where the secondary screw includes a head and a stem, where the stem of the secondary screw inserts into the head of the primary screw.

2. The dual screw configuration according to claim 1, where the secondary screw is for temporary usage and is removable after use.

3. The dual screw configuration according to claim 2, where the primary screw remains in the wall permanently after removal of the secondary screw.

4. A method of screw reinforcement comprising the steps of:
a. inserting a first screw into a wall, where the first screw includes self taping threads;
b. inserting a second screw into an opening provided in the first screw;
c. driving the second screw into the opening along the length of the first screw to reinforce the strength of the first screw;
d. removing the second screw after usage of the second screw; and
e. driving the first screw flush into the wall after completion of use the first screw.
